(19) United States
(12) Patent Application Publication
(10) Pub. No.: US 2025/0320101 A1
(43) Pub. Date: Oct. 16, 2025

(54) CAP ROTATING EQUIPMENT

(71) Applicant: Marketech International Corp., TAIPEI CITY (TW)

(72) Inventors: Ping-Hsu CHEN, Taichung City (TW); Chien-Kuo LU, Hsinchu City (TW)

(21) Appl. No.: 18/918,722

(22) Filed: Oct. 17, 2024

(30) Foreign Application Priority Data
Apr. 10, 2024 (TW) 113113446

(51) Int. Cl. B67B 3/20; B67B 7/18

(52) U.S. Cl. CPC B67B 3/2066; B67B 7/182

(57) ABSTRACT

A cap rotating equipment includes a power rotating shaft, a cap rotating housing and a cap fixing device. The cap rotating housing is connected to the power rotating shaft, and the cap rotating housing includes an opening. The cap fixing device is installed in the opening of the cap rotating housing and is used to clamp a cap of a bottle.

### RELATED APPLICATIONS

This application claims priority to Taiwan Application Serial Number 113113446, filed Apr. 10, 2024, the disclosures of which are incorporated herein by reference in their entireties.

### TECHNICAL FIELD

The present disclosure relates to a cap rotating equipment. More particularly, the present disclosure relates to a cap rotating equipment of a sampling bottle.

### BACKGROUND

With the booming of the domestic and international semiconductor markets in recent years, due to the demand for computers and the peripheral products thereof, the semiconductor industry has continued to expand, and created a large amount of foreign exchange earnings.

The manufacturing processes of semiconductor components are very complicated, and the technologies involved cover almost all of the most important and critical technologies and inventions of modern scientific research. Therefore, the semiconductor industry is not only a cutting-edge technology industry, but also requires a lot of money to maintain high-end research.

Due to the increasingly complicated design of semiconductor components, the manufacturing technologies of semiconductor components are becoming more sophisticated and complex, and the potential occupational hazards and property losses are becoming more serious in semiconductor processes. Chemical liquids are commonly used in processes such as epitaxy, diffusion, ions implantation, chemical vapor deposition, etching and lithography.

In a semiconductor fabrication plant, chemical liquids are stored in chemical storage drums to connect to a supply line in the semiconductor fabrication plant. In the current semiconductor production system, more than 30 chemical liquids may be supplied to the production line at the same time. In order to ensure the quality and yield of component production, various chemical liquids must be tested regularly.

However, while opening the sampling bottle or closing the bottle cap of the sampling bottle, the sampling process of the chemical liquid under test may be not only inconvenient to operate, but also more likely to cause pollution. Therefore, there is a need to conveniently carry out the process to open and close the bottle cap so as to improve inspection quality and reduce sample contamination to further improve the quality and productivity of semiconductor production.

### SUMMARY

The summary of the present invention is intended to provide a simplified description of the disclosure to enable readers to have a basic understanding of the disclosure. The summary of the present invention is not a complete overview of the disclosure, and it is not intended to point out the importance of the embodiments/key elements of the present invention or define the scope of the invention.

One objective of the embodiments of the present invention is to provide a cap rotating equipment able to conveniently detect and rotate the bottle cap so as to conveniently open or close the bottle cap of the bottle.

To achieve these and other advantages and in accordance with the objective of the embodiments of the present invention, as the embodiment broadly describes herein, the embodiments of the present invention provides a cap rotating equipment including a power rotating shaft, a cap rotating housing and a cap fixing device. The cap rotating housing is connected to the power rotating shaft, and the cap rotating housing includes an opening. The cap fixing device is installed in the opening of the cap rotating housing to clamp a bottle cap of a bottle.

In some embodiments, the cap fixing device includes a pneumatic expansion ring to clamp or release the bottle cap of the bottle according to a value of air pressure in the pneumatic expansion ring.

In some embodiments, the cap fixing device further includes a corrosion-resistant contact layer formed inside the pneumatic expansion ring.

In some embodiments, the corrosion-resistant contact layer is a perfluoroalkoxy alkane (PFA) contact layer.

In some embodiments, the corrosion-resistant contact layer includes a corrugated surface complementary to a texture on a side surface of the bottle cap.

In some embodiments, the cap rotating housing includes a bottle storage area and a first guiding portion connected to the bottle storage area to guide a bottle body of the bottle into the bottle storage area.

In some embodiments, the cap rotating housing further includes a bottle cap storage area and a second guiding portion connected to the bottle cap storage area to guide the bottle cap of the bottle into the bottle cap storage area.

In some embodiments, a height of the bottle storage area plus the first guiding portion is greater than a height measured from a bottle cap top surface to a bottle shoulder of the bottle body.

In some embodiments, the cap rotating equipment further includes a bottle cap sensor equipped in the bottle cap storage area of the cap rotating housing to detect the bottle cap of the bottle.

In some embodiments, the bottle cap sensor is a limit switch, a proximity switch, an optical sensor, a laser sensor or an infrared sensor.

Hence, the cap rotating equipment can safely and conveniently open or close the bottle cap on the bottle to facilitate the acquisition of samples of chemical liquids used in semiconductor production lines and reduce possibility of human or environmental contamination so as to improve the efficiency and accuracy of the sampling process and further improve the yield and output of the semiconductor process, thereby increasing the revenue and profits of semiconductor production.

### BRIEF DESCRIPTION OF THE DRAWINGS

The disclosure can be more fully understood by reading the following detailed description of the embodiment, with reference made to the accompanying drawings as follows:

FIG. 1 illustrates a schematic diagram showing a cap rotating equipment according to one embodiment of the present invention; and

FIG. 2 illustrates a schematic cross-sectional view of a cap rotating equipment according to an embodiment of the present invention.

### DETAILED DESCRIPTION OF THE PREFERRED EMBODIMENT

The following is a detailed description of the embodiments in conjunction with the accompanying drawings, but the provided embodiments are not intended to limit the scope of the disclosure, and the description of the structure and operation is not used to limit the execution sequence thereof. The structure of the recombination of components and the resulting devices with equal functions are all within the scope of this disclosure. In addition, the drawings are for illustration purposes only, and are not drawn according to the original scale. For ease of understanding, the same reference numbers are used in the drawings and the description to refer to the same or like parts.

In addition, the terms used in the entire description and the scope of the patent application, unless otherwise specified, usually have the usual meaning of each term used in this field, in the content disclosed here and in the special content. Some terms used to describe the disclosure are discussed below or elsewhere in this specification to provide additional guidance to those skilled in the art in the disclosure.

In the implementation mode and the scope of the present application, unless the article is specifically limited in the context, “a” and “the” can generally refer to a single or pluralities. In the steps, the numbering is only used to conveniently describe the steps, rather than to limit the sequence and implementation.

Secondly, the words “comprising”, “including”, “having”, “containing” and the like used in the present application are all open language, meaning including but not limited thereto.

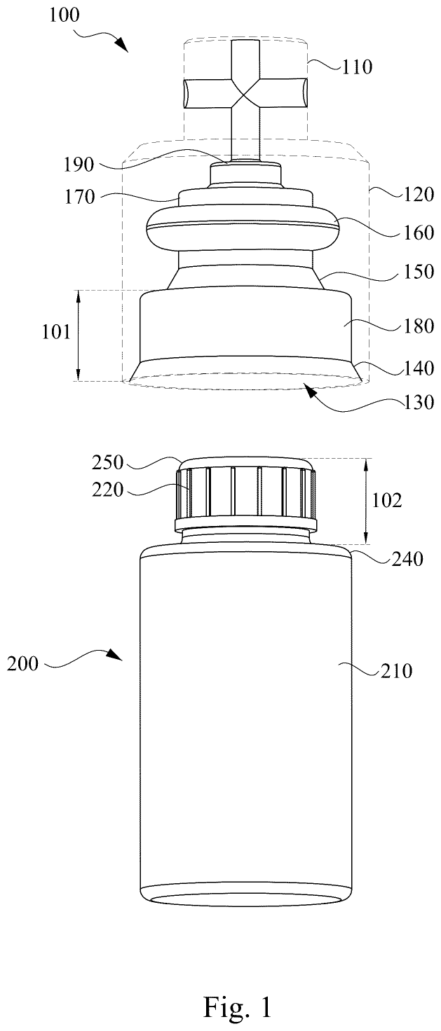

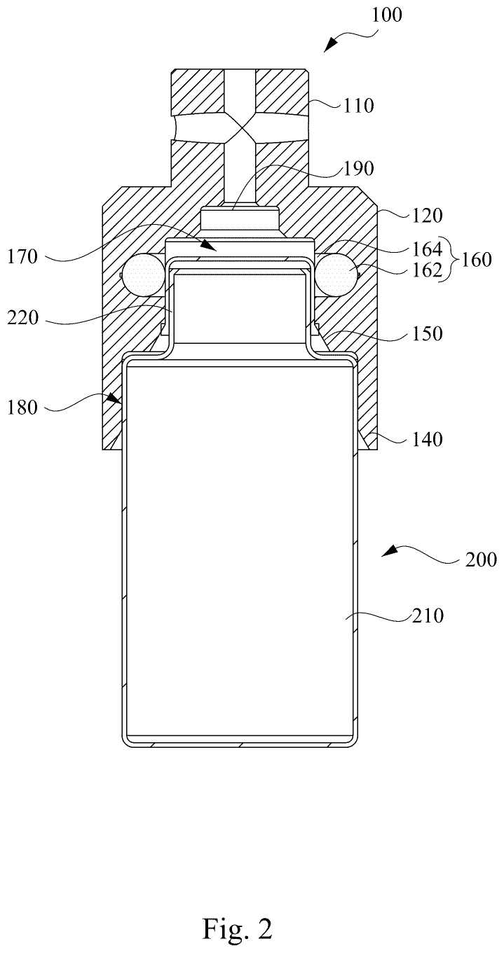

FIG. 1 illustrates a schematic diagram showing a cap rotating equipment according to one embodiment of the present invention and FIG. 2 illustrates a schematic cross-sectional view thereof.

Simultaneously referring to FIGS. 1 and 2, as shown in the drawings, the cap rotating equipment 100 includes a power rotating shaft 110, a cap rotating housing 120 and a cap fixing device 160. The power rotating shaft 110 is connected to the cap rotating housing 120 to drive the cap rotating housing 120 so as to open or close the bottle cap 220 of the bottle 200. In addition, the cap rotating housing 120 includes an opening 130, and the cap fixing device 160 is installed in the opening 130 of the cap rotating housing 120 to clamp the bottle cap 220 of the bottle 200.

In some embodiments, the cap fixing device 160 includes a pneumatic expansion ring 162 to clamp or release the bottle cap 220 of the bottle 200 by changing the volume of the pneumatic expansion ring 162 according to the air pressure in the pneumatic expansion ring 162. Subsequently, the power rotating shaft 110 and the cap rotating housing 120 may further rotate the bottle cap 220 of the bottle 200 to open or close the bottle cap 220 of the bottle 200.

In some embodiments, the cap fixing device 160 further includes a corrosion-resistant contact layer 164 formed inside the pneumatic expansion ring 162. In addition, the corrosion-resistant contact layer 164 may be a perfluoroalkoxy alkane (PFA) contact layer to avoid corrosion of the pneumatic expansion ring 162 caused by corrosive liquid so as to extend the service life of the cap rotating equipment 100.

In some embodiments, the PFA, a high chemical stability material, contact layer is a thermoplastic fluororesin with excellent chemical, electrical, and mechanical properties to avoid corrosion by most chemical liquids. In addition, the PFA contact layer is also suitable for continuous contact with highly active chemical liquids to extend the service life of the cap rotating equipment 100.

In some embodiments, the corrosion-resistant contact layer 164 includes a corrugated surface to increase the friction force.

In some embodiments, the corrosion-resistant contact layer 164 includes a corrugated surface and the texture of the corrugated surface is complementary to the texture on the side surface of the bottle cap 220 so as to increase the torque to rotate the bottle cap 220.

In some embodiments, a first guiding portion 140, a bottle storage area 180, a second guiding portion 150 and a bottle cap storage area 170 are sequentially formed in the opening 130 of the cap rotating housing 120.

The first guiding portion 140 is connected to the bottle storage area 180 to guide the bottle body 210 of the bottle 200 to be stably and accurately inserted into the bottle storage area 180. In addition, when the bottle cap 220 passing through the first guiding portion 140, the first guiding portion 140 may effectively adjust the position of the bottle 200 to guide the bottle body 210 and the bottle cap 220 of the bottle 200 to align to the center of the opening 130 of the cap rotating housing 120.

In addition, the second guiding portion 150 is connected to the bottle cap storage area 170 to guide the bottle cap 220 of the bottle 200 to be accurately and stably entered into the bottle cap storage area 170. In addition, the cap fixing device 160 is equipped inside the bottle cap storage area 170. When the bottle cap 220 is accurately entered into the bottle cap storage area 170, the pneumatic expansion ring 162 is operated to tightly clamp the bottle cap 220 by the pneumatic expansion ring 162 and the corrosion-resistant contact layer 164. The power rotating shaft 110 subsequently drives the cap rotating housing 120 to rotate the bottle cap 220 of the bottle 200 so as to open the bottle cap 220 of the bottle 200. In addition, the cap fixing device 160 may continuously hold the opened bottle cap 220. After the required chemical liquid is injected into the bottle 200, the cap fixing device 160 reversely rotates the bottle cap 220 to fix the bottle cap 220 on the bottle body 210 of the bottle 200.

In some embodiments, the power rotating shaft 110 may further moves up and down to move the cap rotating housing 120 and the bottle cap 220 held in the cap rotating housing 120 up and down.

In some embodiments, the bottle body 210 includes a bottle shoulder 240, and the bottle cap 220 includes a bottle cap top surface 250. In addition, the bottle shoulder 240 and the bottle cap top surface 250 preferably include rounded edges to conveniently guide the bottle 200 to be aligned with a center of the cap rotating housing 120 through the first guiding portion 140 and the second guiding portion 150.

In some embodiments, a height 101 of the bottle storage area 180 plus the first guiding portion 140 is preferably greater than a height 102 measured from the bottle cap top surface 250 of the bottle cap 220 to the bottle shoulder 240 of the bottle body 210 to improve the guidance stability and guidance accuracy.

In some embodiments, the cap rotating equipment 100 further includes a bottle cap sensor 190 equipped inside the bottle cap storage area 170 of the cap rotating housing 120 to detect whether or not the bottle cap 220 of the bottle 200 is accurately positioned in the opening 130 of the cap rotating housing 120.

In some embodiments, the bottle cap sensor 190 is a limit switch, a proximity switch, an optical sensor, a laser sensor and/or an infrared sensor to detect whether or not the bottle cap 220 of the bottle 200 is accurately positioned in the opening 130 of the cap rotating housing 120. In addition, the bottle cap sensor 190 may also detect a position of the bottle 200 in advance to improve the process accuracy and stability without departing from the spirit and scope of the disclosure.

In some embodiments, the bottle 200 may be used to contain hydrofluoric acid (HF) solution, nitric acid solution, phosphoric acid solution, acetic acid solution, and hydrogen peroxide solution, deionized water (DI water) and/or sulfuric acid solution, etc., for the sampling process but not limited thereto.

Accordingly, the cap rotating equipment can safely and conveniently open or close the bottle cap on the bottle to facilitate the acquisition of samples of chemical liquids used in semiconductor production lines and reduce possibility of human or environmental contamination so as to improve the efficiency and accuracy of the sampling process, and further improve the yield and output of the semiconductor process, thereby increasing the revenue and profits of semiconductor production.

Although the present disclosure has been disclosed above in terms of implementation, it is not intended to limit the present disclosure. Any person with ordinary knowledge in the field may make various variations and modifications without departing from the spirit and scope of the disclosure. Therefore, the spirit and scope of the appended claims should not be limited to the description of the embodiments contained herein.

What is claimed is:

1. A cap rotating equipment, comprising:
a power rotating shaft;
a cap rotating housing connecting to the power rotating shaft, wherein the cap rotating housing comprises an opening; and
a cap fixing device installing in the opening of the cap rotating housing to clamp a bottle cap of a bottle.

2. The cap rotating equipment of claim 1, wherein the cap fixing device comprises a pneumatic expansion ring to clamp or release the bottle cap of the bottle according to a value of air pressure in the pneumatic expansion ring.

3. The cap rotating equipment of claim 2, wherein the cap fixing device further comprises:
a corrosion-resistant contact layer formed inside the pneumatic expansion ring.

4. The cap rotating equipment of claim 3, wherein the corrosion-resistant contact layer is a perfluoroalkoxy alkane (PFA) contact layer.

5. The cap rotating equipment of claim 3, wherein the corrosion-resistant contact layer comprises a corrugated surface complementary to a texture on a side surface of the bottle cap.

6. The cap rotating equipment of claim 3, wherein the cap rotating housing comprises:
a bottle storage area; and
a first guiding portion connected to the bottle storage area to guide a bottle body of the bottle into the bottle storage area.

7. The cap rotating equipment of claim 6, wherein the cap rotating housing further comprises:
a bottle cap storage area; and
a second guiding portion connected to the bottle cap storage area to guide the bottle cap of the bottle into the bottle cap storage area.

8. The cap rotating equipment of claim 7, wherein a height of the bottle storage area plus the first guiding portion is greater than a height measured from a bottle cap top surface to a bottle shoulder of the bottle body.

9. The cap rotating equipment of claim 7, further comprising a bottle cap sensor equipped in the bottle cap storage area of the cap rotating housing to detect the bottle cap of the bottle.

10. The cap rotating equipment of claim 9, wherein the bottle cap sensor is a limit switch, a proximity switch, an optical sensor, a laser sensor or an infrared sensor.
